(19) United States
(12) Patent Application Publication
(10) Pub. No.: US 2019/0360534 A1
(43) Pub. Date: Nov. 28, 2019

(54) SEGMENTED SUPPORT ELEMENT

(71) Applicant: Schaeffler Technologies AG & Co. KG, Herzogenaurach (DE)

(72) Inventors: Palmiro Lanzillotti, Endingen (DE); Markus Hesse, Pfinztal (DE)

(21) Appl. No.: 16/332,097

(22) PCT Filed: Oct. 12, 2017
(86) PCT No.: PCT/DE2017/100863

§ 371 Date: Mar. 11, 2019

(30) Foreign Application Priority Data
Oct. 19, 2016 (DE) 10 2016 220 499.8

(51) Int. Cl. F16D 13/64; F16D 65/12

(52) U.S. Cl. CPC F16D 13/648; F16D 2065/1312; F16D 65/121

(57) ABSTRACT

A segmented support element for at least one lining element includes at least two support segments. support segments are not directly, but indirectly connected to one another.

The present disclosure concerns a segmented support element for at least one lining element, with at least two support segments.

### BACKGROUND

German publication DE 10 2013 212 185 A1 describes a segmented support plate for at least one lining element such as a clutch plate, with at least two segments which are connected together by substance bonding. German publication DE 10 2007 053 758 A1 discloses a segmented support plate for a clutch plate which is composed of at least two segments, forming a boundary line between the segments in the manner of a jigsaw puzzle, wherein the one segment has a protrusion which is inserted in a recess in the other segment to form a boundary line portion between the protrusion and the recess, and the protrusion and the recess are shaped such that adjacent segments undercut each other relative to the circumferential direction in at least a first and a second part portion of the boundary line portion, wherein the projection of the first part portion in the circumferential direction on a radius at least partially overlaps with the projection of the second part portion in the circumferential direction on said radius.

### SUMMARY OF THE INVENTION

An object of the present disclosure is to provide a segmented support element with at least two support segments for at least one lining element, which support element is economic to produce and/or has a long service life.

A segmented support element is provided with at least two support segments for at least one lining element, in that the support segments are not directly but indirectly connected to each other. The support element is for example formed as a support plate. Support elements or support plates are used for example in wet-running clutch systems as the basis for lining plates or friction plates. Due to the absence of a direct connection, for example a substance-bonded or form-fit connection, between the individual support segments, a significantly greater utilization of material becomes possible. In addition, production of the segmented support elements is simplified, in particular in large series. The individual support segments are advantageously punched out of a suitable sheet metal material. Due to the absence of a direct connection between the support segments, in addition and particularly advantageously, larger component thicknesses may be used for the segmented support elements. Furthermore, the long-term stability of the segmented support element in operation is increased. Segmented support elements in which the support segments are connected together indirectly are suitable for forming friction plates both with inner toothing and with outer toothing.

A preferred exemplary embodiment of the segmented support element is characterized in that the support segments are indirectly connected together via a plate carrier. The plate carrier is for example an inner plate carrier or an outer plate carrier. Via the plate carrier, the support segments can easily be connected together in a stable fashion. The plate carrier is advantageously configured as a sheet metal part.

A further preferred exemplary embodiment of the segmented support element is characterized in that the support segments are connected to the plate carrier by form fit, such that the support segments are fixed in both the radial direction and in the circumferential direction relative to the plate carrier. In a simple fashion, this design prevents the support segments from moving relative to each other in an undesirable manner during operation.

A further preferred exemplary embodiment of the segmented support element is characterized in that, radially inwardly/outwardly, the support segments constitute a common form-fit geometry which is complementary to a form-fit geometry of an inner plate carrier/outer plate carrier. The common form-fit geometry of the support segments is advantageously configured as toothing. The individual teeth of the toothing are here shaped such that the support segments are fixed in both the radial direction and in the circumferential direction relative to the plate carrier. The term “radial” refers here to a rotation axis about which the segmented support element with the support segments rotates in operation. “Radially” means transversely to the rotation axis. The term “circumferential direction” also refers to the rotation axis of the support element.

A further preferred exemplary embodiment of the segmented support element is characterized in that the form-fit geometry comprises intermeshing toothing with undercuts on at least two teeth per support segment on a common pitch circle of the intermeshing toothings. In a simple fashion, the undercuts prevent relative movements of the support segments in the radial direction. Individual teeth may also comprise a passage hole through which a fixing element extends which is fixedly connected to the plate carrier. The undercut may however also be formed by at least one lug on a tooth which extends in the circumferential direction. To form an undercut, individual teeth of the toothing may also be configured so as to be substantially circular. Advantageously, the undercuts need not be provided on all teeth of the toothing.

A further preferred exemplary embodiment of the segmented support element is characterized in that a root diameter/tip diameter of the support element is larger, at least at one point per tooth, than a tip diameter/root diameter of the inner plate carrier/outer plate carrier. Thus an undesirable radial shift of the support segments relative to each other can be avoided in a simple fashion.

A further preferred exemplary embodiment of the segmented support element is characterized in that the support segments each comprise at least one undulation extending in the circumferential direction. The undulation may advantageously be created directly on production of the support segments. Relative to the support element which comprises several segments, the undulation comprises for example four to nine waves.

A further preferred exemplary embodiment of the segmented support element is characterized in that the support segments have one-dimensional geometries at their mutually facing abutting edges. The abutting edges of the support segments are for example designed as straight lines. The individual support segments are delimited radially inwardly and radially outwardly preferably by circle arcs. The lateral abutting edges of the support segments are preferably part portions of radii.

A further preferred exemplary embodiment of the segmented support element is characterized in that the support element has substantially the form of a circular ring disc. The support segments constituting the support element may bear against each other with their mutually facing abutting edges but are not directly connected together. Depending on design, the individual support segments constituting the support element may also be spaced apart from each other in the circumferential direction.

The present disclosure furthermore concerns a friction lining plate, in particular a wet-running friction lining plate, with a segmented support element as described above. A suitable friction lining material may be attached to the individual support segments, or to the segmented support element comprising several support segments, using conventional methods.

The present disclosure also concerns a support segment for a segmented support element as described above. The support segment may be provided separately. The support segment is preferably a punched part.

### BRIEF SUMMARY OF THE DRAWINGS

Further advantages, features and details of the present disclosure arise from the description below in which various exemplary embodiments are described in detail with reference to the drawing. The drawings show:

FIGS. 1 to 7 simplified depictions each of two support segments which are arranged on a plate carrier to form a segmented support element, and

FIG. 8 a plate carrier designed as an inner plate carrier and on which, radially outwardly, a total of six support segments are attached which are indirectly connected together solely via the plate carrier.

### DETAILED DESCRIPTION

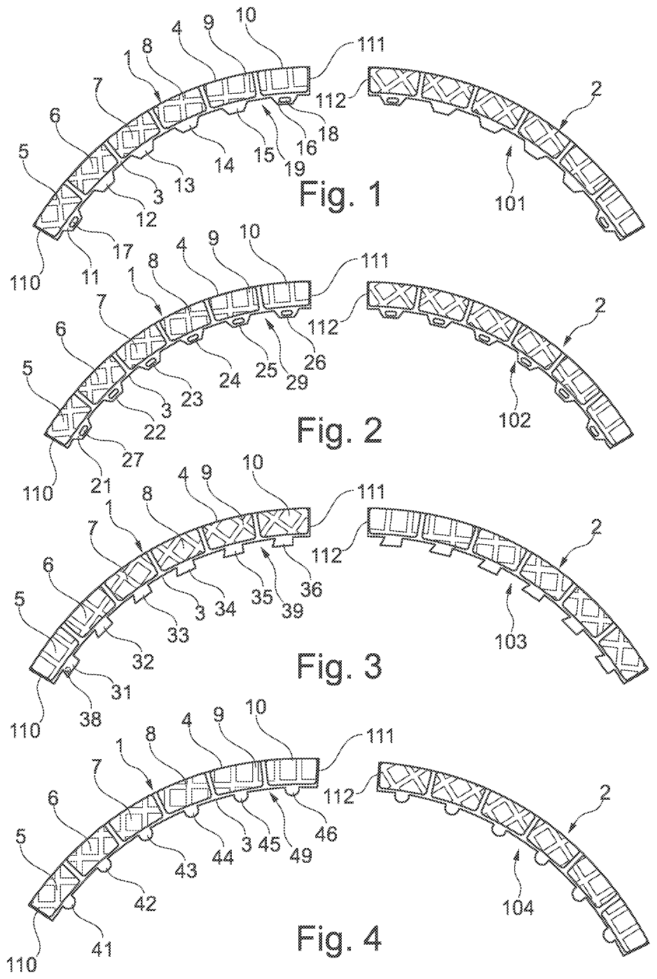

FIGS. 1 to 7 each show in top view two support segments 1, 2 of identical design. The support segment 1 comprises an inner radius 3 and an outer radius 4. At the side, the support segment 1 is delimited by two straight abutting edges 110, 111.

The right-hand abutting edge 111 shown in FIG. 1 faces an abutting edge 112, also designed as a straight line, of the support segment 2. To form a support element, the support segments 1, 2 are positioned such that they bear against each other with their mutually facing abutting edges 111, 112.

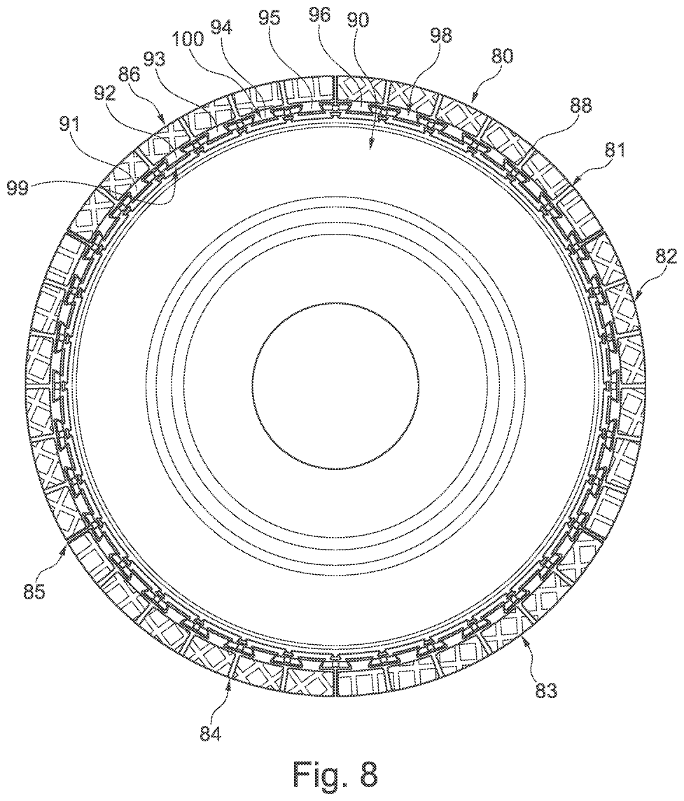

Depending on design, the abutting edges 111, 112 of the support segments 1, 2 may also be slightly spaced apart from each other in mounted state, as shown in FIG. 8.

The support segment 1 is formed as a punched part from a suitable sheet metal material. A total of six friction lining elements 5 to 10 are arranged on the support segment 1. The friction lining elements 5 to 10 are designed and arranged on the support segment 1 so that radial grooves result between individual friction lining elements 5 to 10.

In addition, the friction lining elements 5 to 10 may be provided with a specific structure, in particular grooving. The grooves between the friction lining elements 5 to 10 and the optional structure of the friction lining elements 5 to 10 serve to improve clutch cooling in operation of the friction clutch, in particular in a wet-running clutch system.

To form various form-fit geometries 101 to 107, inner toothings 19; 29; 39; 49; 59; 69; 79 are formed on the support segments 1, 2. To create a form fit with undercuts, the inner toothings 19; 29; 39; 49; 59; 69; 79 each comprise a total of six teeth 11 to 16; 21 to 26; 31 to 36; 41 to 46; 51 to 56; 61 to 66; 71 to 76 which are formed on the support segment 1.

In the exemplary embodiment shown in FIG. 1, the teeth 11 to 16 each have the form of an isosceles trapezium. The teeth 11 to 16 taper radially inwardly. The two teeth 11 and 16 arranged at the ends of the support segment 1 each have a passage hole 17, 18.

The passage holes 17, 18 serve for stable fixing of the support segment 1 to a plate carrier. To fix the support segment 1 to the plate carrier, the teeth 11 and 16 are for example pressed onto a structure of the plate carrier, such that a fixing element protruding from the plate carrier extends through the passage hole 17; 18 of the respective tooth 11; 16.

In the exemplary embodiment shown in FIG. 2, all the teeth 21 to 26 have a passage hole 27. In the same way, the associated plate carrier is provided with a total of six protrusions onto which the teeth are pressed such that the protrusions engage in or through the respective passage hole 27. The engagement of the protrusions in the respective passage hole 27 creates a form-fit connection with an undercut.

In the exemplary embodiment shown in FIG. 3, the teeth 31 to 36 each have an oblique edge 38 which serves to create an undercut on form-fit connection of the support segment 1 to an associated plate carrier. All teeth 31 to 36 are designed identically. This simplifies production of the support segment 1.

In the exemplary embodiment shown in FIG. 4, all teeth 41 to 46 of the support segment 1 have the form of a circle. A segment is cut away from the circle at the point at which the respective tooth 41 to 46 is integrally connected to an arcuate base body of the support segment 1. The circular forms of the teeth 41 to 46 serve to create undercuts on form-fit connection of the support segment 1 to a plate carrier (not shown in FIG. 4).

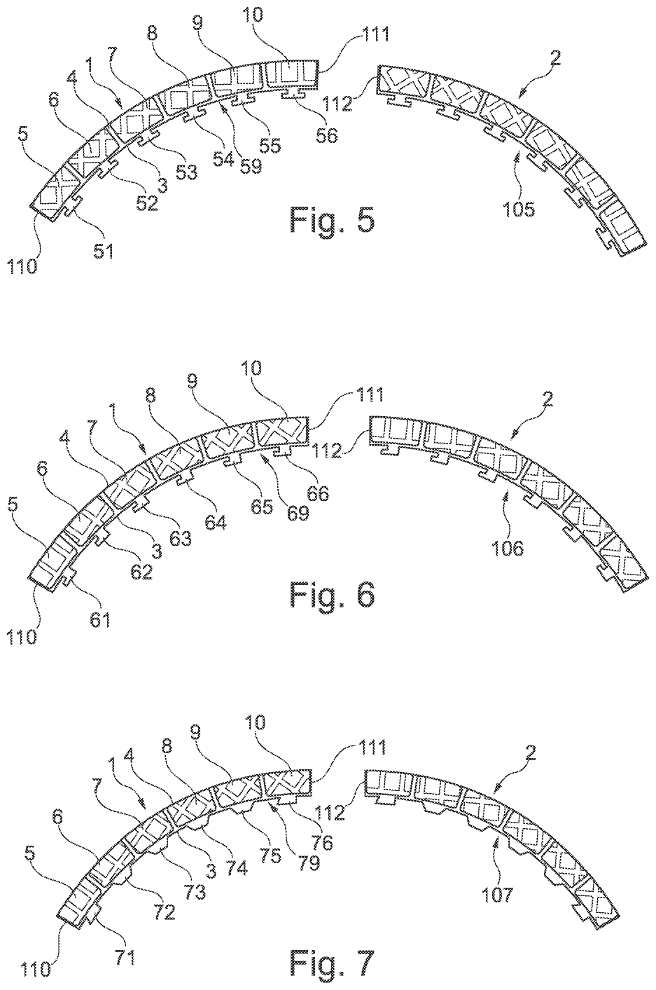

In the exemplary embodiment shown in FIG. 5, the teeth 51 to 56 are formed substantially T-shaped on the support segment 1. A crossbar of the T-shaped form of the teeth 51 to 56 is arranged radially inwardly and serves to create undercuts on form-fit connection of the support segment 1 to a corresponding plate carrier.

In the exemplary embodiment shown in FIG. 6, the teeth 61 to 66 are formed so as to be substantially L-shaped. The L-shaped form of the teeth 61 to 66 serves to create undercuts on form-fit connection of the carrier segment 1 to a corresponding plate carrier. An angled arm of the L-shaped form constitutes a lug extending in the circumferential direction.

In the exemplary embodiment shown in FIG. 7, the teeth 72 to 75 are formed in the same way as teeth 12 to 15 in the exemplary embodiment shown in FIG. 1. The teeth 71 and 76 in the exemplary embodiment shown in FIG. 7 are formed in the same way as the teeth 31 to 36 in the exemplary embodiment shown in FIG. 3. Thus only the teeth 71 to 76 serve to create undercuts on form-fit connection of the support segment 1 to the corresponding plate carrier.

FIG. 8 shows in top view a plate 80 with a support element 88. The support element 88 comprises a total of six support segments 81 to 86. The support segments 81 to 86 are connected by form fit to a plate carrier 90 configured as an inner plate carrier.

The inner plate carrier 90 is configured for example as a sheet metal part with an outer toothing which is complementary to an inner toothing 99 of the support element 88. To form the inner toothing 99 of the support element 88, the support segment 86 comprises a total of six teeth 91 to 96, in a similar fashion to the support segment 1 in FIGS. 1 to 7.

The teeth 91 to 96 have the form of isosceles trapeziums. The isosceles trapeziums of the teeth 91 to 96 however widen radially inwardly, in contrast to the exemplary embodiment shown in FIG. 1.

In this way, undercuts can be formed when the inner toothing 99 of the support segments 81 to 86, forming form-fit geometries 98, is brought into engagement with the outer toothing of the plate carrier 90, forming a complementary form-fit geometry 100.

### LIST OF REFERENCE SIGNS

1 Support segment
2 Support segment
3 Inner radius
4 Outer radius
5 Friction lining element
6 Friction lining element
7 Friction lining element
8 Friction lining element
9 Friction lining element
10 Friction lining element
11 Tooth
12 Tooth
13 Tooth
14 Tooth
15 Tooth
16 Tooth
17 Passage hole
18 Passage hole
19 Inner toothing
21 Tooth
22 Tooth
23 Tooth
24 Tooth
25 Tooth
26 Tooth
27 Passage hole
29 Inner toothing
31 Tooth
32 Tooth
33 Tooth
34 Tooth
35 Tooth
36 Tooth
38 Oblique edge
39 Inner toothing
41 Tooth
42 Tooth
43 Tooth
44 Tooth
45 Tooth
46 Tooth
49 Inner toothing
51 Tooth
52 Tooth
52 Tooth
54 Tooth
55 Tooth
56 Tooth
59 Inner toothing
61 Tooth
62 Tooth
63 Tooth
64 Tooth
65 Tooth
66 Tooth
69 Inner toothing
71 Tooth
72 Tooth
73 Tooth
74 Tooth
75 Tooth
76 Tooth
79 Inner toothing
80 Plate
81 Support segment
82 Support segment
83 Support segment
84 Support segment
85 Support segment
86 Support segment
88 Support element
90 Inner plate carrier
91 Tooth
92 Tooth
93 Tooth
94 Tooth
95 Tooth
96 Tooth
98 Form-fit geometry
99 Inner toothing
100 Form-fit geometry
101 Form-fit geometry
102 Form-fit geometry
103 Form-fit geometry
104 Form-fit geometry
105 Form-fit geometry
106 Form-fit geometry
107 Form-fit geometry

1-10. (canceled)

11. A segmented support element comprising:
at least two support segments for at least one lining element, the at least two support segments not being directly connectable to each other, the at least two support segments being indirectly connectable to each other.

12. The segmented support element as claimed in claim 11, wherein the at least two support segments are indirectly connectable together via a plate carrier.

13. The segmented support element as claimed in claim 12, wherein the at least two at least two support segments are connected to the plate carrier by a form fit such that the at least two support segments are fixed in both a radial direction and in a circumferential direction relative to the plate carrier.

14. The segmented support element as claimed in claim 11, wherein, radially inwardly or outwardly, the at least two support segments constitute a common form-fit geometry which is complementary to a form-fit geometry of an inner plate carrier or an outer plate carrier.

15. The segmented support element as claimed in claim 14, wherein the form-fit geometry comprises intermeshing toothing with undercuts on at least two teeth per each of the at least two support segments on a common pitch circle of the intermeshing toothing.

16. The segmented support element as claimed in claim 15, wherein a root diameter or tip diameter of the segmented support element is larger, at least at one point per tooth, than a tip diameter or root diameter of the inner plate carrier or the outer plate carrier.

17. The segmented support element as claimed in claim 11, wherein the at least two support segments each comprise at least one undulation extending in the circumferential direction.

18. The segmented support element as claimed in claim 11, wherein the at least two support segments have one-dimensional geometries at mutually facing abutting edges of the at least two support segments.

19. The segmented support element as claimed in claim 11, wherein the segmented support element has substantially a form of a circular ring disc.

20. A friction lining plate comprising the segmented support element as claimed in claim 11.

21. The friction lining plate as claim in claim 20 wherein the friction lining plate is a wet-running friction lining plate.

22. A method of making a friction lining plate comprising:
making at least two support segments that are not directly connectable to each other; and
indirectly connecting the at least two support segments together.

23. The method as recited in claim 22 wherein the indirectly connecting of the at least two support segments together includes connecting the at least two support segments to a plate carrier.

24. The method as recited in claim 23 wherein the connecting of the at least two support segments to the plate carrier includes connecting teeth of the at least two support segments in a form fit with teeth of the plate carrier.

25. The method as recited in claim 24 wherein the teeth of the at least two support segments are connected in the form fit with the teeth of the plate carrier via undercuts of the teeth of the at least two support segments.

26. A friction lining plate comprising:
at least two support segments that are not directly connected to each other; and
a plate carrier, the at least two support segments being connected to the plate carrier so the at least two support segments are indirectly connected together by the plate carrier.

27. The friction lining plate as recited in claim 26 wherein each of the at least two support segments includes at least one friction lining element.

28. The friction lining plate as recited in claim 26 wherein the at least two support segments are connected to the plate carrier by teeth of the at least two support segments being connected in a form fit with teeth of the plate carrier.

29. The friction lining plate as recited in claim 28 wherein the teeth of the at least two support segments are connected in the form fit with teeth of the plate carrier via undercuts of the teeth of the at least two support segments.
